(19) United States
(12) Patent Application Publication
(10) Pub. No.: US 2022/0236082 A1
(43) Pub. Date: Jul. 28, 2022

(54) ROTATION MONITORING ASSEMBLY FOR AN ARTIFICIAL LIFT SYSTEM

(71) Applicant: Mesquite Technologies LLC, Austin, TX (US)

(72) Inventors: Jose Roberto Navar, Austin, TX (US); Baldev R. Patel, Austin, TX (US); Troy Alfred Poage, Midland, TX (US)

(21) Appl. No.: 17/586,292

(22) Filed: Jan. 27, 2022

Related U.S. Application Data
(60) Provisional application No. 63/142,319, filed on Jan. 27, 2021.

(51) Int. Cl. G01D 5/22; E21B 43/12

(52) U.S. Cl. CPC G01D 5/2291; E21B 43/126

(57) ABSTRACT

A rotation monitoring assembly for an artificial lift system includes a sensor having a body configured to couple to one of a non-rotating component of a polish rod connection assembly or a rotating component of the polish rod connection assembly. The rotation monitoring assembly also includes a target configured to couple to the other of the non-rotating component of the polish rod connection assembly or the rotating component of the polish rod connection assembly. A property of the target varies substantially continuously along a circumferential extent of the target, and the sensor is configured to output a sensor signal indicative of the property of the target.

### CROSS-REFERENCE TO RELATED APPLICATION

This application claims priority from and the benefit of U.S. Provisional Application Ser. No. 63/142,319, entitled “ROTATION MONITORING ASSEMBLY FOR AN ARTIFICIAL LIFT SYSTEM”, filed Jan. 27, 2021, which is hereby incorporated by reference in its entirety.

### BACKGROUND

The present disclosure relates generally to a rotation monitoring assembly for an artificial lift system.

Wells are drilled into reservoirs to discover and produce oil. The oil within such a reservoir may be under sufficient pressure to drive the oil through the well to the surface. However, over time, the natural pressure of the oil may decline, and an artificial lift system may be used to extract the oil from the reservoir. The artificial lift system may include a pump disposed within the reservoir and a wellhead at the surface. A tubing string may be supported by the wellhead and may extend to the reservoir, and the pump may drive the oil from the reservoir to the wellhead via the tubing string.

The pump is driven by a series of polish rods that extend through the tubing string to the pump. The polish rods are lifted and lowered by a pump jack, which supports the polish rods. The repeated lifting and lowering movement of the polish rods causes the polish rods to wear at the point(s) of contact with the tubing string. Accordingly, certain artificial lift systems include a rod rotator to drive the polish rods to rotate within the tubing string, thereby distributing the wear around the circumference of the polish rods. As a result, the longevity of the polish rods may be increased.

However, if rotation of the polish rods is terminated during operation of the artificial lift system, polish rod wear at the point(s) of contact may increase. Accordingly, an operator may periodically perform a visual inspection of the polish rods to determine whether the polish rods are rotating effectively. If the polish rods are not rotating effectively, the operator may perform maintenance operations (e.g., on the rod rotator). Unfortunately, the process of visually inspecting the polish rods for each artificial lift system within a field may be excessively time-consuming.

### BRIEF DESCRIPTION

In certain embodiments, a rotation monitoring assembly for an artificial lift system includes a sensor having a body configured to couple to one of a non-rotating component of a polish rod connection assembly or a rotating component of the polish rod connection assembly. The rotation monitoring assembly also includes a target configured to couple to the other of the non-rotating component of the polish rod connection assembly or the rotating component of the polish rod connection assembly. A property of the target varies substantially continuously along a circumferential extent of the target, and the sensor is configured to output a sensor signal indicative of the property of the target.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic side view of an embodiment of an artificial lift system having an embodiment of a rotation monitoring assembly;

FIG. 2 is a schematic side view of a portion of the artificial lift system of FIG. 1, including a wellhead and a polish rod connection assembly;

FIG. 3 is a schematic perspective view of the polish rod connection assembly of FIG. 2, in which the polish rod connection assembly includes the rotation monitoring assembly;

FIG. 4 is a schematic perspective view of a mounting assembly of the rotation monitoring assembly of FIG. 3; and

FIG. 5 is a perspective view of a rod rotator assembly of the polish rod connection assembly of FIG. 2, in which a portion of the rod rotator assembly is cut away, and an embodiment of a rotation monitoring assembly.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

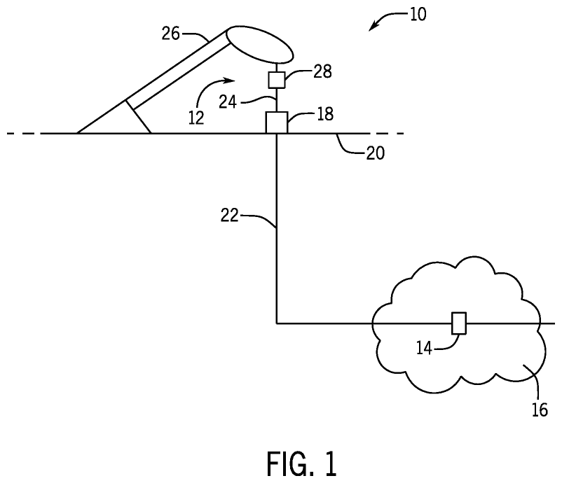

FIG. 1 is a schematic side view of an embodiment of an artificial lift system 10 having an embodiment of a rotation monitoring assembly 12. As illustrated, the artificial lift system 10 includes a pump 14 disposed within a reservoir 16. The artificial lift system 10 also includes a wellhead 18 at the surface 20. A tubing string 22, which is supported by the wellhead 18, extends from the surface 20 to the reservoir 16. The pump 14 is configured to drive oil from the reservoir 16 to the surface 20 via the tubing string 22 and the wellhead 18.

The pump 14 is driven by a series of polish rods that extend through the tubing string 22 to the pump 14. As illustrated, a polish rod 24 at the end of the series of polish rods is coupled to a pump jack 26 of the artificial lift system 10. The pump jack 26 is configured to lift and lower the polish rods, thereby driving the pump 14. One or more polish rods may contact the tubing string 22 at one or more points along a circumference of the polish rod(s). Accordingly, as the polish rods are driven to move within the tubing string 22, certain point(s) on the polish rod(s) may wear. In the illustrated embodiment, a rod rotator assembly 28 is configured to drive the polish rods to rotate within the tubing string 22, thereby distributing the wear around the circumference of the polish rod(s). As a result, the longevity of the polish rods may be increased. As discussed in detail below, the rod rotator assembly 28 is supported by a carrier (e.g., carrier bar) that is supported by the pump jack 26 via one or more cables.

In certain embodiments, the rod rotator assembly 28 includes a housing supported by the carrier of the artificial lift system 10. In addition, the rod rotator assembly 28 includes a top cap configured to rotate relative to the housing, in which the top cap is configured to support the polish rods (e.g., via polish rod clamp(s)). Furthermore, in certain embodiments, the rotation monitoring assembly 12 is utilized to monitor the rotation of the polish rods, thereby facilitating identification of ineffective operation of the rod rotator assembly 28. The rotation monitoring assembly 12 includes a sensor having a contact element and a body. The body of the sensor is coupled to the housing of the rod rotator assembly, and the sensor is configured to output a sensor signal indicative of a position of the contact element relative to the body. In addition, the rotation monitoring assembly 12 includes one or more targets coupled to a rotating portion of the rod rotator assembly 28, such as the end cap. Each target includes a contact surface configured to engage the contact element of the sensor, and a longitudinal extent of the contact surface (e.g., property of the target) varies (e.g., substantially continuously) along a circumferential extent of the target. Due to the variation in the longitudinal extent of the contact surface along the circumferential extent of the target, the contact surface may drive the contact element of the sensor to move relative to the sensor body as the rotating portion of the rod rotator assembly (e.g., the top cap) rotates relative to the rod rotator assembly housing. Accordingly, the sensor signal indicative of the position of the contact element relative to the body, which is based on the longitudinal extent of the contact surface (e.g., the property of the target), may vary as the rotating portion of the rod rotator assembly rotates. The sensor signal may be monitored (e.g., by a controller having a memory and a processor) to identify whether the polish rods are not rotating or are not rotating at a target rate, thereby enabling an operator to perform maintenance operations on the artificial lift system (e.g., on the rod rotator assembly).

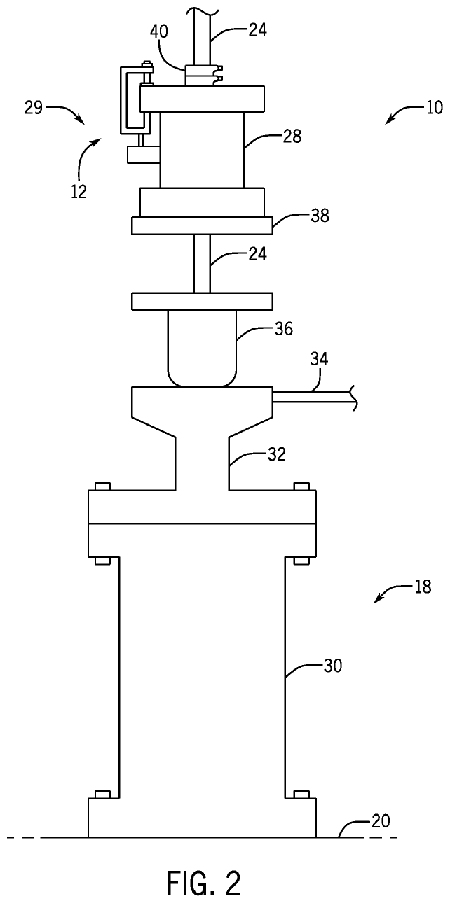

FIG. 2 is a schematic side view of a portion of the artificial lift system 10 of FIG. 1, including the wellhead 18 and a polish rod connection assembly 29. In the illustrated embodiment, the wellhead 18 includes a tubing spool 30 that supports the tubing string (e.g., via a tubing hanger coupled to an end of the tubing string and engaged with the tubing spool). The wellhead 18 also includes a pumping tee 32 coupled to the tubing spool 30 and to a flowline 34. The pumping tee 32 is configured to receive oil from the tubing spool 30 and to control flow of the oil through the flowline 34. The flowline 34 may extend to a storage or processing facility. Furthermore, the wellhead 18 includes a stuffing box 36 coupled to the pumping tee 32. The stuffing box is configured to establish a seal around the polish rod 24 that substantially blocks flow of oil through the polish rod/stuffing box interface while enabling the upward/downward movement of the polish rod. While the wellhead 18 includes the tubing spool 30, the pumping tee 32, and the stuffing box 36 in the illustrated embodiment, the wellhead may include other and/or additional components in other embodiments.

As discussed in detail below, the polish rod connection assembly 29 includes the rod rotator assembly 28, which is configured to drive the polish rods to rotate relative to the wellhead 18 and the tubing string. The polish rod connection assembly 29 also includes a carrier 38 (e.g., carrier bar) configured to support the rod rotator assembly 28. The carrier 38 may be coupled to the pump jack by one or more cables. In addition, the polish rod connection assembly 29 includes one or more polish rod clamps 40 configured to non-movably couple to the polish rod 24. The polish rod clamps 40 transfer the load (e.g., substantially vertical load) of the polish rods to the rod rotator assembly 28, the load flows through the rod rotator assembly 28 to the carrier 38, and the load applied to the carrier is transferred to the pump jack via the cable(s). Accordingly, during an upward movement of the pump jack, the pump jack lifts the carrier 38 via the cable(s), the carrier 38 drives the rod rotator assembly 28 to move upwardly, and the rod rotator assembly 28 drives the polish rods to move upwardly via engagement of the rod rotator assembly 28 with the polish rod clamp(s) 40. During a downward movement of the pump jack, the pump jack drives the polish rod 24 downwardly. Because the polish rod clamp(s) 40 are non-movably coupled to the polish rod 24, the polish rod clamp(s) 40 drive the rod rotator assembly 28 to move downwardly, thereby driving the carrier 38 to move downwardly.

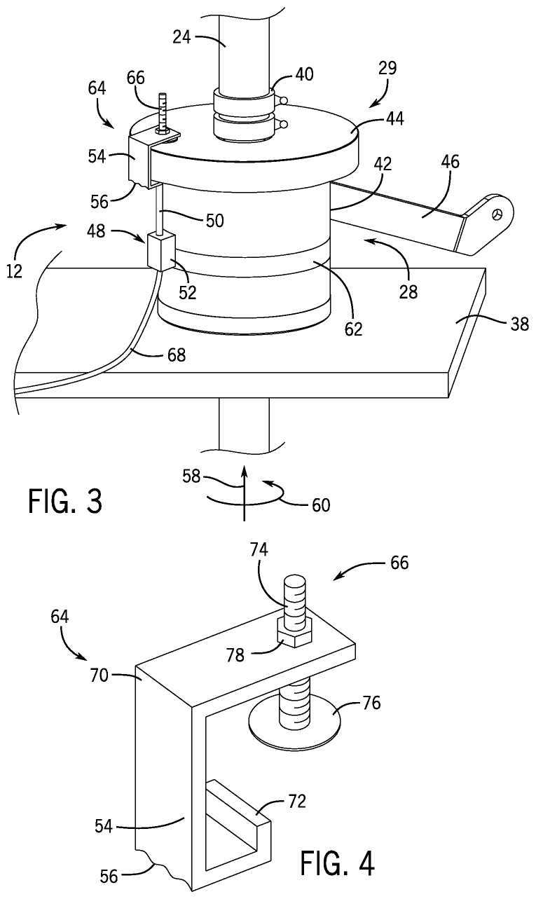

FIG. 3 is a schematic perspective view of the polish rod connection assembly 29 of FIG. 2. As previously discussed, the polish rod connection assembly 29 includes the rotation monitoring assembly 12, the rod rotator assembly 28, the carrier 38, and the polish rod clamps 40. In the illustrated embodiment, the rod rotator assembly 28 includes a housing 42, which is supported by the carrier 38. The rod rotator assembly 28 also includes a top cap 44 configured to rotate relative to the housing 42. As illustrated, the top cap 44 is engaged with the polish rod clamp(s) 40, thereby supporting the polish rods. In addition, due to the engagement of the top cap 44 with the polish rod clamp(s) 40, rotation of the top cap 44 relative to the housing 42 drives the polish rods to rotate, thereby increasing the longevity of the polish rods. While the polish rod connection assembly 29 includes two polish rod clamps 40 in the illustrated embodiment, in other embodiments, the polish rod connection assembly may include more or fewer polish rod clamps (e.g., 1, 3, 4, or more).

In the illustrated embodiment, the rod rotator assembly 28 includes a lever 46 configured to drive the top cap to rotate. The lever 46 may be coupled to a worm gear of the rod rotator assembly 28, and movement of the lever may drive the worm gear to rotate. The worm gear may be engaged with a main gear of the rod rotator assembly 28 and configured to drive the main gear to rotate. The main gear, in turn, may be non-rotatably coupled to the top cap 44. Accordingly, movement of the lever 46 may drive the top cap 44 to rotate, thereby driving the polish rods to rotate via contact between the top cap 44 and the polish rod clamp(s) 40. The lever 46 may be driven to move via a cable extending between the lever 46 and a base of the pump jack. As the rod rotator assembly 28 moves upwardly and downwardly with the polish rods during operation of the pump jack, the cable cyclically drives the lever 46 to move in response to the rod rotator assembly 28 moving to a distance away from the pump jack cable anchor point that is greater than the length of the cable. While the top plate 44 is driven to rotate by the lever 46, the worm gear, and the main gear in the embodiment disclosed herein, the top plate may be driven to rotate relative to the rod rotator assembly housing via any other suitable device/assembly (e.g., electric motor, pneumatic actuator, another suitable mechanical drive assembly, etc.).

In the illustrated embodiment, the rotation monitoring assembly 12 includes a sensor 48 having a contact element 50 and a body 52. The body 52 of the sensor 48 is coupled to the housing 42 of the rod rotator assembly 28 (e.g., non-rotating component of the polish rod connection assembly 29), and the sensor 48 is configured to output a sensor signal indicative of a position of the contact element 50 relative to the body 52. In certain embodiments, the sensor 48 includes a linear variable differential transformer (LVDT) having a core coupled to the contact element 50 and multiple coils extending around a central passage within the body 52. In such embodiments, the sensor signal may correspond to a voltage output by the LVDT, and movement of the core within the central passage may vary the voltage output/sensor signal. Additionally or alternatively, the sensor 48 may include any other suitable type(s) of position monitoring device(s) (e.g., alone or in combination with one or more LVDTs), such as linear potentiometer(s), optical sensor(s), other suitable type(s) of position monitoring device(s), or a combination thereof. While the rotation monitoring assembly 12 includes a single sensor 48 in the illustrated embodiment, in other embodiments, the rotation monitoring assembly may include multiple sensors (e.g., distributed about a circumferential axis 60 of the rod rotator assembly 28).

In addition, the rotation monitoring assembly 12 includes a target 54 non-rotatably coupled to the top cap 44 (e.g., rotating component of the polish rod connection assembly 29), such that the target 54 rotates with the top cap 44. The target 54 includes a contact surface 56 configured to engage the contact element 50 of the sensor 48. In addition, a longitudinal extent of the contact surface 56 (e.g., extent of the contact surface along a longitudinal axis 58 of the rod rotator assembly 28), which is a property of the target, varies (e.g., substantially continuously) along a circumferential extent of the target 54 (e.g., extent of the target along the circumferential axis 60 of the rod rotator assembly 28). Due to the variation in the longitudinal extent of the contact surface 56 along the circumferential extent of the target 54, the contact surface 56 may drive the contact element 50 of the sensor 48 to move relative to the sensor body 52 as the top cap 44 rotates relative to the rod rotator assembly housing 42. Accordingly, the sensor signal indicative of the position of the contact element 50 relative to the body 52, which is based on the longitudinal extent of the contact surface (e.g., property of the target), may vary as the top cap 44 rotates. The sensor signal may be monitored (e.g., by a controller having a memory and a processor) to identify whether the polish rods are not rotating or are not rotating at a target rate, thereby enabling an operator to perform maintenance operations on the artificial lift system (e.g., on the rod rotator assembly). In addition, because the longitudinal extent of the contact surface varies (e.g., substantially continuously) along the circumferential extent of the target, a non-rotating/improperly rotating polish rod may be identified rapidly, as compared to utilizing a rotation monitoring assembly that identifies presence of a rotating target at the location of a non-rotating sensor, which may only identify non-rotation/improper rotation of a polish rod after a substantial portion of a rotation of the top cap (e.g., which may only rotate once per 40-50 oscillations of the pump jack).

In certain embodiments, the contact element 50 is biased away from the body 52 (e.g., by a spring or other suitable biasing element). Accordingly, the contact element 50 of the sensor 48 is urged into contact with the contact surface 56 of the target 54. Furthermore, in certain embodiments (e.g., in embodiments in which the target extends about the entire circumferential extent of the top cap), the contact element of the sensor may be coupled to the contact surface of the target. For example, the contact surface of the target may be formed on a rail or track that extends along the circumferential axis of the rod rotator assembly, and the contact element may include an engagement element (e.g., wheel, slider, etc.) engaged with the rail or track.

In the illustrated embodiment, the body 52 of the sensor 48 is coupled to the housing 42 of the rod rotator assembly 28 by a strap 62 that extends about the circumferential extent of the rod rotator assembly housing 42. However, in other embodiments, the sensor may be coupled to the housing by other suitable type(s) of connection(s) (e.g., alone or in combination with the strap), such as welded connection(s), adhesive connection(s), fastener connection(s), other suitable type(s) of connection(s), or a combination thereof. In addition, the target 54 is part of a mounting assembly 64, which is coupled to the top cap 44 via a clamp 66 of the mounting assembly 64. As discussed in detail below, the mounting assembly 64 includes a bracket having a lower lip configured to engage a bottom surface of the top cap 44, and the clamp 66 is configured to selectively engage an engagement surface (e.g., top surface) of the top cap 44, thereby coupling the mounting assembly 64 to the top cap 44. While the mounting assembly includes a bracket and a clamp in the illustrated embodiment, in other embodiments, the mounting assembly may include other and/or additional component(s) (e.g., fastener(s), latch(es), etc.) configured to couple the target to the top cap. Furthermore, while the target 54 is coupled to the top cap 44 via the mounting assembly 64 in the illustrated embodiment, in other embodiments, the target may be coupled to the top cap by any other suitable type(s) of connection(s) (e.g., alone or in combination with the mounting assembly), such as adhesive connection(s), a press-fit connection, a threaded connection, fastener connection(s), welded connection(s), other suitable type(s) of connection(s), or a combination thereof.

While the target 54 is coupled to the top cap 44 in the illustrated embodiment, in other embodiments, the target may be coupled to another suitable rotating portion of the rod rotator assembly. For example, in certain embodiments, the target may be coupled to the main gear, which is configured to drive the top cap to rotate, or the target may be coupled to a rotating shaft of a motor (e.g., electric motor), which is configured to drive the top cap to rotate. In such embodiments, the body of the sensor may be coupled to an internal surface of the rod rotator assembly housing by any suitable connection(s) (e.g., adhesive connection(s), welded connection(s), fastener connection(s), etc.). Furthermore, in certain embodiments, the target may be coupled to the top cap radially inward from the outer wall of the rod rotator assembly housing. In such embodiments, the body of the sensor may be coupled to an internal surface of the rod rotator assembly housing by any suitable connection(s) (e.g., adhesive connection(s), welded connection(s), fastener connection(s), etc.). In addition, in certain embodiments, the sensor, the target, and in certain embodiments, mounting component(s) for the sensor and/or the target (e.g., the strap for mounting the sensor, the mounting assembly for mounting the target, etc.) may be sold as a kit (e.g., retrofit kit) configured to provide polish rod rotation monitoring functionality to an artificial lift system.

In the illustrated embodiment, the rotation monitoring assembly 12 includes a single target 54 extending about a portion of the circumferential extent of the rod rotator assembly 28. However, in other embodiments, the rotation monitoring assembly may include additional targets, and each target may have any suitable circumferential extent. For example, in certain embodiments, the rotation monitoring assembly may include 2, 3, 4, 5, 6, or more targets. The targets may be spaced apart from one another along the circumferential axis, and the circumferential spacing between targets may be substantially equal or varied. Furthermore, in certain embodiments, the rotation monitoring assembly may include a single target that extends about an entire circumferential extent of the rod rotator assembly (e.g., such that the contact element of the sensor maintains contact with the contact surface of the target throughout the rotation of the rotating portion, such as the top cap, of the rod rotator assembly).

The sensor 48 may output the sensor signal indicative of the position of the contact element 50 relative to the body 52 via a wired or wireless connection. In the illustrated embodiment, a sensor cable 68 extends from the sensor 48 toward a monitoring/control system, and the sensor signal may be output via the sensor cable 68. However, in other embodiments, the sensor may be communicatively coupled to the monitoring/control system via a wireless connection. The wireless connection may utilize any suitable wireless communication protocol, such as Bluetooth, WiFi, radio frequency identification (RFID), a proprietary protocol, or a combination thereof.

FIG. 4 is a schematic perspective view of the mounting assembly 64 of the rotation monitoring assembly of FIG. 3. As previously discussed, the target 54 is part of the mounting assembly 64, and the mounting assembly 64 is configured to couple to the top cap of the rod rotator assembly via the clamp 66. In the illustrated embodiment, the mounting assembly 64 includes a bracket 70 having a lower lip 72 configured to engage a bottom surface of the top cap. In addition, the clamp 66 includes a threaded shaft 74 and a contact pad 76 coupled to the threaded shaft 74. As illustrated, the threaded shaft 74 is engaged with a nut 78 of the bracket 70. The contact pad 76 is configured to selectively engage the engagement surface (e.g., the top surface) of the top cap, and rotation of the threaded shaft 74 is configured to control the position of the contact pad 76 relative to the lower lip 72. To couple the mounting assembly 64 to the top cap, the lower lip 72 of the bracket 70 is engaged with the bottom surface of the top cap, and the threaded shaft 74 of the clamp 66 is rotated such that the contact pad 76 of the clamp 66 engages the engagement surface of the top cap. While the clamp 66 includes the threaded shaft 74, and the bracket 70 includes the nut 78 in the illustrated embodiment, in other embodiments, the mounting assembly may include any other suitable device(s)/system(s) configured to selectively drive the contact pad to engage the top surface of the top cap, such as latch(es), hydraulic actuator(s), electromechanical actuator(s), etc.

In the illustrated embodiment, the target 54 is part of the bracket 70, such that the contact surface 56 of the target 54 is formed on the bracket 70. However, in other embodiments, the target may be formed as a separate element and coupled to the bracket. Furthermore, as previously discussed, the longitudinal extent of the contact surface 56 varies along the circumferential extent of the target 54. In the illustrated embodiment, the longitudinal extent of the contact surface 56 varies substantially continuously along the circumferential extent of the target 54. As used herein, “varies substantially continuously” refers to a continuous variation, or variations having multiple changes in magnitude (e.g., longitudinal extent), as compared to single-magnitude discrete variations. While the longitudinal extent of the contact surface varies substantially continuously along the circumferential extent of the target in the illustrated embodiment, in other embodiments, the longitudinal extent of the contact surface may vary discretely with single-magnitude variations along the circumferential extent of the target. In the illustrated embodiment, the contact surface 56 forms a wave pattern (e.g., substantially continuous wave pattern). However, in other embodiments, the contact surface may form any other suitable pattern (e.g., linear ramped pattern, curved ramped pattern, notched pattern, etc.) to facilitate monitoring of the rotation of the polish rods. For example, in embodiments in which the contact surface has a ramped pattern (e.g., the longitudinal extent of the contact surface increases or decreases substantially continuously along the circumferential extent of the target), the rotation monitoring assembly may facilitate determination of the angular position of the polish rods (e.g., by utilizing a stored relationship between position of the contact element of the sensor and an angular position of the polish rods).

While the sensor is coupled to the housing of the rod rotator assembly and the target is coupled to a rotating portion of the rod rotator assembly in the illustrated embodiment, in other embodiments, the sensor may be coupled to another suitable non-rotating component of the polish rod connection assembly, such as the carrier, and the target may be coupled to another suitable rotating component of the polish rod connection assembly, such as the polish rod clamp(s). Furthermore, in certain embodiments, the sensor may be coupled to a rotating component of the polish rod connection assembly (e.g., the top cap, the polish rod clamp(s), etc.), and the target may be coupled to a non-rotating component of the polish rod connection assembly (e.g., the rod rotator assembly housing, the carrier, etc.).

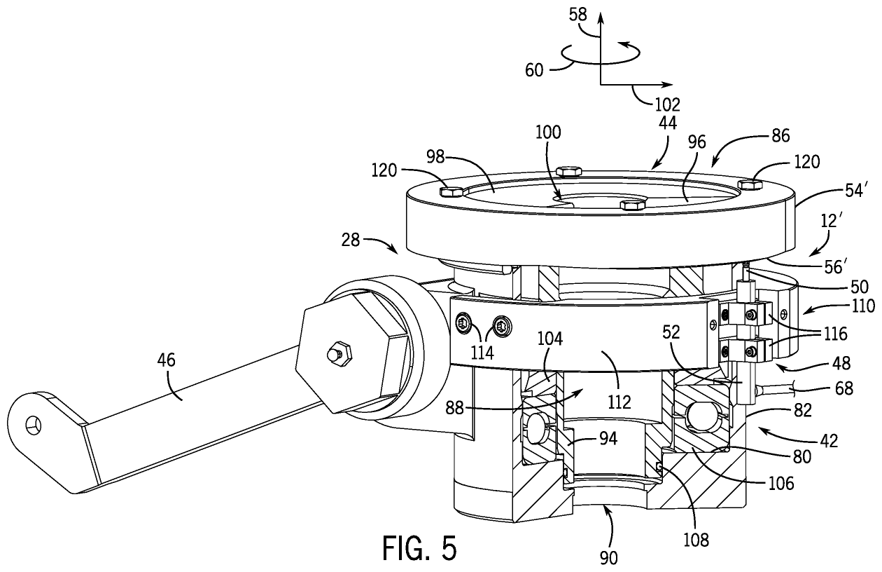

FIG. 5 is a perspective view of the rod rotator assembly 28 of the polish rod connection assembly of FIG. 2, in which a portion of the rod rotator assembly 28 is cut away, and an embodiment of a rotation monitoring assembly 12′. As previously discussed, the rod rotator assembly 28 includes a housing 42, which is supported by the carrier. In the illustrated embodiment, the housing 42 includes a base 80 and a body 82 extending upwardly from the base 80 along the longitudinal axis 58 of the rod rotator assembly 28. The body 82 forms a first opening 86 on an opposite longitudinal side of the housing 42 from the base 80, and the first opening 86 provides access to an interior 88 of the housing 42. Furthermore, in the illustrated embodiment, the base 80 of the housing 42 forms a second opening 90. The openings in the housing 42 facilitate passage of the polish rod through the housing 42. In certain embodiments, an annular bushing may be disposed within the second opening 90. In such embodiments, the annular bushing may be configured to contact the polish rod, thereby substantially blocking dirt and/or debris from entering the housing interior via the second opening. Furthermore, in certain embodiments, the annular bushing may be omitted. While the housing 42 has an annular shape in the illustrated embodiment, in other embodiments, the housing may have any other suitable shape (e.g., polygonal, elliptical, irregular, etc.).

Furthermore, as previously discussed, the rod rotator assembly 28 includes a top cap 44 configured to rotate relative to the housing 42. The top cap 44 is configured to rotate along the circumferential axis 60 of the rod rotator assembly 28. Furthermore, as previously discussed, the top cap 44 is configured to support the polish rods via the polish rod clamp(s). In the illustrated embodiment, the top cap 44 includes a body 94 and a platform 96. The body 94 extends through the first opening 86 in the housing 42 into the interior 88 of the housing 42, and the platform 96 has an engagement surface 98 configured to engage the polish rod clamp(s), thereby supporting the polish rods. In the illustrated embodiment, the platform 96 of the top cap 44 has an opening 100 configured to facilitate passage of the polish rod (e.g., top polish rod) through the platform 96. In addition, the body 94 of the top cap 44 is configured to be disposed outwardly from the polish rod along a radial axis 102 of the rod rotator assembly 28, thereby facilitating passage of the polish rod through the body 94. While the body 94 of the top cap 44 extends through the first opening 86 of the housing 42 into the interior 88 of the housing 42 in the illustrated embodiment, in other embodiments, the body may not extend into the housing interior (e.g., the body may be non-rotatably coupled to a component of the rod rotator assembly positioned at least partially outside of the housing, such as the main gear). Furthermore, in certain embodiments, the body of the top cap may be omitted (e.g., the platform of the top cap may be non-rotatably coupled to a component of the rod rotator assembly, such as the main gear).

In the illustrated embodiment, the rod rotator assembly 28 includes a main gear 104, which is non-rotatably coupled to the body 94 of the top cap 44. The main gear 104 may be non-rotatably coupled to the body 94 of the top cap 44 via any suitable type(s) of connection(s), such as welded connection(s), a press-fit connection, fastener connection(s), adhesive connection(s), other suitable type(s) of connection(s), or a combination thereof. As previously discussed, the main gear 104 is configured to be driven to rotate by a worm gear. In the illustrated embodiment, movement of the lever 46 drives the worm gear to rotate, thereby driving the main gear 104 to rotate. Due to the non-rotatable coupling between the main gear 104 and the body 94 of the top cap 44, rotation of the main gear 104 drives the top cap 44 to rotate, thereby driving the polish rods to rotate via the contact between the engagement surface 98 of the top cap 44 and the polish rod clamp(s). While the main gear 104 is driven to rotate by a worm gear coupled to the lever 46 in the illustrated embodiment, in other embodiments, the main gear may be driven to rotate by a motor (e.g., electric motor, hydraulic motor, pneumatic motor, etc.). Furthermore, in certain embodiments, the main gear may be omitted, and a motor (e.g., electric motor, hydraulic motor, pneumatic motor, etc.) may drive the top cap to rotate, as discussed above with reference to FIG. 3.

In the illustrated embodiment, the rod rotator assembly 28 includes a bearing 106 disposed between the main gear 104 and the base 80 of the housing 42 along the longitudinal axis 58 of the rod rotator assembly 28. The bearing 106 enables the main gear 104 to rotate relative to the housing 42. In the illustrated embodiment, the bearing 106 includes a ball bearing (e.g., including multiple bearing balls between two races). However, in other embodiments, the bearing may include other suitable type(s) of bearing(s) (e.g., alone or in combination with one or more ball bearings), such as roller bearing(s), fluid bearing(s), other suitable type(s) of bearing(s), or a combination thereof. Furthermore, while the rod rotator assembly 12 includes a single bearing 106 in the illustrated embodiment, in other embodiments, the rod rotator assembly may include more or fewer bearings (e.g., 0, 2, 3, 4, or more). For example, in certain embodiments, the bearing may be omitted. In such embodiments, a bushing may be disposed between the main gear and the base of the housing along the longitudinal axis of the rod rotator assembly.

In the illustrated embodiment, the rod rotator assembly 28 includes a first seal 108 (e.g., o-ring, etc.) disposed between the housing 42 and the top cap body 94 along the radial axis 102, thereby establishing a seal between the top cap body 94 and the housing 42. The first seal 108 is configured to substantially block dirt and/or debris from entering a cavity between the top cap body and the housing body. While the rod rotator assembly includes a single seal between the housing and the top cap body in the illustrated embodiment, in other embodiments, the rod rotator assembly may include more or fewer seals between the housing and the top cap body (e.g., 0, 2, 3, 4, or more). For example, in certain embodiments, the first seal may be omitted. Furthermore, in certain embodiments, the rod rotator assembly may include a second seal (e.g., o-ring, etc.) disposed between the platform of the top cap and the body of the housing along the radial axis. The second seal may be configured to substantially block dirt and/or debris from entering the cavity between the top cap body and the housing body. While a single seal disposed between the platform and the housing body along the radial axis is disclosed above, in certain embodiments, more or fewer seals (e.g., 0, 2, 3, 4, or more) may be disposed between the platform and the housing body along the radial axis.

In the illustrated embodiment, the rotation monitoring assembly 12′ includes a sensor 48 having a contact element 50 and a body 52. The sensor 48 is configured to output a sensor signal indicative of a position of the contact element 50 relative to the body 52. As previously discussed, in certain embodiments, the sensor 48 includes a linear variable differential transformer (LVDT) having a core coupled to the contact element 50 and multiple coils extending around a central passage of the body 52. In such embodiments, the sensor signal may correspond to a voltage output by the LVDT, and movement of the core within the central passage may vary the voltage output/sensor signal. Additionally or alternatively, the sensor 48 may include any other suitable type(s) of position monitoring device(s), such as linear potentiometer(s), optical sensor(s), other suitable type(s) of position monitoring device(s), or a combination thereof. While the rotation monitoring assembly 12′ includes a single sensor 48 in the illustrated embodiment, in other embodiments, the rotation monitoring assembly may include multiple sensors (e.g., distributed about the circumferential axis 60 of the rod rotator assembly 28).

In the illustrated embodiment, the rotation monitoring assembly 12′ includes a mount 110 that couples the body 52 of the sensor 48 to the body 82 of the housing 42. As illustrated, the mount 110 includes an arcuate support 112 that extends about a portion of a periphery of the body 82 of the housing 42 along the circumferential axis 60 of the rod rotator assembly 28. In the illustrated embodiment, the arcuate support 112 is coupled to the body 82 of the housing 42 via fasteners 114. However, in other embodiments, the arcuate support may be coupled to the body of the housing via other suitable type(s) of connection(s) (e.g., alone or in combination with the illustrated fastener connection), such as welded connection(s), adhesive connection(s), a press-fit connection, other suitable type(s) of connection(s), or a combination thereof. Furthermore, in the illustrated embodiment, the mount 110 includes two brackets 116 coupled to the arcuate support 112 and to the body 52 of the sensor 48. Accordingly, the body 52 of the sensor 48 is coupled to the housing 42 via the brackets 116 and the arcuate support 112. In the illustrated embodiment, each bracket 116 is configured to couple to the sensor body 52 via a clamped connection (e.g., to enable adjustment of the position of the sensor body 52 along the longitudinal axis 58). However, in other embodiments, at least one bracket may be coupled to the sensor body via other suitable type(s) of connection(s) (e.g., alone or in combination with the clamped connection), such as fastener connection(s), adhesive connection(s), a press-fit connection, other suitable type(s) of connection(s), or a combination thereof. Furthermore, in the illustrated embodiment, each bracket 116 is coupled to the arcuate support 112 via a fastener connection. However, in other embodiments, at least one of the brackets may be coupled to the arcuate support via other suitable type(s) of connection(s) (e.g., alone or in combination with the illustrated fastener connection), such as welded connection(s), adhesive connection(s), other suitable type(s) of connection(s), or a combination thereof. Furthermore, while the mount 110 includes two brackets 116 in the illustrated embodiment, in other embodiments, the mount may include more or fewer brackets (e.g., 0, 1, 3, 4, or more).

While the body 52 of the sensor 48 is coupled to the arcuate support 112 via bracket(s) 116 in the illustrated embodiment, in other embodiments, the sensor body may be coupled to the arcuate support via other suitable type(s) of connection(s) (e.g., alone or in combination with the bracket(s)), such as adhesive connection(s), fastener connection(s), welded connection(s), a press-fit connection, other suitable type(s) of connection(s), or a combination thereof. Furthermore, while the mount 110 includes the arcuate support 112 in the illustrated embodiment, in other embodiments, the mount may include any other suitable structure(s) to facilitate coupling the sensor body to the housing (e.g., alone or in combination with the arcuate support), such as an annular support, support(s) having other suitable shape(s), or a combination thereof. In addition, in certain embodiments, the mount may be omitted, and the sensor body may be coupled to the housing via other suitable type(s) of connection(s), such as the strap disclosed above with reference to FIG. 3, welded connection(s), adhesive connection(s), fastener connection(s), other suitable type(s) of connection(s), or a combination thereof. Furthermore, while the body 52 of the sensor 48 is coupled to the body 82 of the housing 42 in the illustrated embodiment, in other embodiments, the body of the sensor may be coupled to another suitable portion of the housing, such as the base.

In addition, the rotation monitoring assembly 12′ includes a target 54′ non-rotatably coupled to the platform 96 of the top cap 44, such that the target 54′ rotates with the top cap 44. The target 54′ includes a contact surface 56′ configured to engage the contact element 50 of the sensor 48. In addition, a longitudinal extent of the contact surface 56′ (e.g., extent of the contact surface along the longitudinal axis 58 of the rod rotator assembly 28) varies (e.g., substantially continuously) along a circumferential extent of the target 54′ (e.g., extent of the target along the circumferential axis 60 of the rod rotator assembly 28). Due to the variation in the longitudinal extent of the contact surface 56′ along the circumferential extent of the target 54′, the contact surface 56′ may drive the contact element 50 of the sensor 48 to move relative to the sensor body 52 as the top cap 44 rotates relative to the rod rotator assembly housing 42. Accordingly, the sensor signal indicative of the position of the contact element 50 relative to the body 52 may vary as the top cap 44 rotates. As previously discussed, the sensor signal may be monitored (e.g., by a controller having a memory and a processor) to identify whether the polish rods are not rotating or are not rotating at a target rate, thereby enabling an operator to perform maintenance operations on the artificial lift system (e.g., on the rod rotator assembly). In addition, because the longitudinal extent of the contact surface varies (e.g., substantially continuously) along the circumferential extent of the target, a non-rotating/improperly rotating polish rod may be identified rapidly, as compared to utilizing a rotation monitoring assembly that identifies presence of a rotating target at the location of a non-rotating sensor, which may only identify non-rotation/improper rotation of a polish rod after a substantial portion of a rotation of the top cap (e.g., which may only rotate once per 40-50 oscillations of the pump jack).

In the illustrated embodiment, the target 54′ is annular and extends about an entire periphery of the platform 96 of the top cap 44. Accordingly, the contact element 50 of the sensor 48 may engage the contact surface 56′ of the target 54′ while the target 54′ is an any orientation along the circumferential axis 60. However, in other embodiments, the target may be arcuate and extend about a portion of the periphery of the platform of the top cap. In the illustrated embodiment, the target 54′ is non-rotatably coupled to the platform 96 of the top cap 44 via fasteners 120. However, in other embodiments, the target may be non-rotatably coupled to the top cap via any other suitable type(s) of connection(s) (e.g., alone or in combination with the fasteners), such as welded connection(s), adhesive connection(s), a press-fit connection, other suitable type(s) of connection(s), or a combination thereof.

As previously discussed, the longitudinal extent of the contact surface 56′ varies along the circumferential extent of the target 54′. In the illustrated embodiment, the longitudinal extent of the contact surface 56′ varies substantially continuously along the circumferential extent of the target 54′. As previously discussed, “varies substantially continuously” refers to a continuous variation, or variations having multiple changes in magnitude (e.g., longitudinal extent), as compared to single-magnitude discrete variations. While the longitudinal extent of the contact surface varies substantially continuously along the circumferential extent of the target in the illustrated embodiment, in other embodiments, the longitudinal extent of the contact surface may vary discretely with single-magnitude variations along the circumferential extent of the target. In the illustrated embodiment, the contact surface 56′ forms a wave pattern (e.g., substantially continuous wave pattern). However, in other embodiments, the contact surface may form any other suitable pattern (e.g., linear ramped pattern, curved ramped pattern, notched pattern, etc.) to facilitate monitoring of the rotation of the polish rods. For example, in embodiments in which the contact surface has a ramped pattern (e.g., the longitudinal extent of the contact surface increases or decreases substantially continuously along the circumferential extent of the target), the rotation monitoring assembly may facilitate determination of the angular position of the polish rods (e.g., by utilizing a stored relationship between position of the contact element of the sensor and an angular position of the polish rods).

In certain embodiments, the contact element 50 is biased away from the body 52 (e.g., by a spring or other suitable biasing element). Accordingly, the contact element 50 of the sensor 48 is urged into contact with the contact surface 56′ of the target 54′. Furthermore, in certain embodiments (e.g., in embodiments in which the target extends about the entire circumferential extent of the top cap), the contact element of the sensor may be coupled to the contact surface of the target. For example, the contact surface of the target may be formed on a rail or track that extends along the circumferential axis of the rod rotator assembly, and the contact element may include an engagement element (e.g., wheel, slider, etc.) engaged with the rail or track.

While the target 54′ is coupled to the top cap 44 in the illustrated embodiment, in other embodiments, the target may be coupled to another suitable rotating portion of the rod rotator assembly. For example, in certain embodiments, the target may be coupled to the main gear, or the target may be coupled to a rotating shaft of a motor (e.g., electric motor), which is configured to drive the top cap to rotate. In such embodiments, the body of the sensor may be coupled to an internal surface of the rod rotator assembly housing by any suitable connection(s) (e.g., adhesive connection(s), welded connection(s), fastener connection(s), etc.). Furthermore, in certain embodiments, the target may be coupled to the top cap radially inward from the body of the rod rotator assembly housing. In such embodiments, the body of the sensor may be coupled to an internal surface of the rod rotator assembly housing by any suitable connection(s) (e.g., adhesive connection(s), welded connection(s), fastener connection(s), etc.). In addition, in certain embodiments, the sensor, the target, and in certain embodiments, mounting component(s) for the sensor and the target (e.g., the target fasteners, the sensor mount etc.) may be sold as a kit (e.g., retrofit kit) configured to provide polish rod rotation monitoring functionality to an artificial lift system.

In the illustrated embodiment, the rotation monitoring assembly 12′ includes a single target 54′ extending about the entire periphery of the top cap 44. However, in other embodiments, the rotation monitoring assembly may include multiple targets, in which each target extends about a portion of the periphery of the top cap. For example, in certain embodiments, the rotation monitoring assembly may include 2, 3, 4, 5, 6, or more targets. The targets may be spaced apart from one another along the circumferential axis, and the circumferential spacing between targets may be substantially equal or varied.

The sensor 48 may output the sensor signal indicative of the position of the contact element 50 relative to the body 52 via a wired or wireless connection. In the illustrated embodiment, a sensor cable 68 extends from the sensor 48 toward a monitoring/control system, and the sensor signal may be output via the sensor cable 68. However, in other embodiments, the sensor may be communicatively coupled to the monitoring/control system via a wireless connection. The wireless connection may utilize any suitable wireless communication protocol, such as Bluetooth, WiFi, radio frequency identification (RFID), a proprietary protocol, or a combination thereof.

While the sensor is coupled to the housing of the rod rotator assembly and the target is coupled to a rotating portion of the rod rotator assembly in the illustrated embodiment, in other embodiments, the sensor may be coupled to another suitable non-rotating component of the polish rod connection assembly, such as the carrier, and the target may be coupled to another suitable rotating component of the polish rod connection assembly, such as the polish rod clamp(s). Furthermore, in certain embodiments, the sensor may be coupled to a rotating component of the polish rod connection assembly (e.g., the top cap, the polish rod clamp(s), etc.), and the target may be coupled to a non-rotating component of the polish rod connection assembly (e.g., the rod rotator assembly housing, the carrier, etc.).

While a contact sensor is disclosed above with regard to the embodiments of FIGS. 3-5, in certain embodiments, the sensor may include a non-contact sensor, such as an inductive sensor, a capacitance sensor, an optical sensor, a radar sensor, a LIDAR sensor, an ultrasonic sensor, other suitable non-contact sensor(s), or a combination thereof. In such embodiments, the sensor may be directed toward a respective surface of the target, and a longitudinal extent of the respective surface of the target (e.g., property of the target) may vary (e.g., substantially continuously) along the circumferential extent of the target. The sensor may output a sensor signal indicative of a distance between the sensor and the respective surface of the target, which is based on the longitudinal extent of the respective surface (e.g., the property of the target). Accordingly, the rotation monitoring assembly may facilitate monitoring polish rod rotation/rotation rate based on the variation in distance between the sensor and the respective surface of the target. While the circumferentially varying property of the target includes the longitudinal extent of the contact surface/respective surface in the embodiments disclosed above, in certain embodiments, the target may have another property that varies (e.g., substantially continuously) along the circumferential extent of the target, such as color, capacitance, electrical conductivity, or another suitable property. For example, a surface of the target facing the sensor may vary (e.g., substantially continuously) in color along the circumferential extent of the target, and the sensor may include a camera configured to detect the color. Accordingly, the camera may output a sensor signal indicative of the color, thereby facilitating monitoring of polish rod rotation/rotation rate based on the variation in color of the surface of the target. As used herein with regard to color, “varies substantially continuously” refers to a continuous color variation, or variations having multiple changes in color, as compared to single-color discrete variations. By way of further example, the target may vary (e.g., substantially continuously) in capacitance or electrical conductivity along the circumferential extent of the target, and the sensor may include a capacitance sensor or an electrical conductivity sensor configured to detect the capacitance/electrical conductivity. Accordingly, the sensor may output a sensor signal indicative of the capacitance/electrical conductivity, thereby facilitating monitoring of polish rod rotation/rotation rate based on the variation in capacitance/electrical conductivity of the target. As previously discussed, “varies substantially continuously” refers to a continuous variation, or variations having multiple changes in magnitude (e.g., capacitance, electrical conductivity, etc.), as compared to single-magnitude discrete variations.

In addition, in certain embodiments, the sensor may include a capacitive sensor (e.g., coupled to one of the housing or the rotating portion of the rod rotator assembly) that extends about at least a portion of the circumferential extent of the rod rotator assembly, and a target (e.g., coupled to the other of the housing or the rotating portion of the rod rotator assembly) may be detectable by the capacitive sensor. In such embodiments, the sensor may output a sensor signal indicative of the circumferential position of the target, thereby facilitating monitoring of the polish rod rotation/rotation rate. Furthermore, in certain embodiments, the sensor may include multiple optical sensors (e.g., coupled to one of the housing or the rotating portion of the rod rotator assembly) distributed about at least a portion of the circumferential extent of the rod rotator assembly, and a target (e.g., coupled to the other of the housing or the rotating portion of the rod rotator assembly) may be detectable by the optical sensors. In such embodiments, the sensor may output a sensor signal indicative of the circumferential position of the target, thereby facilitating monitoring of the polish rod rotation/rotation rate.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A rotation monitoring assembly for an artificial lift system, comprising:
a sensor having a body configured to couple to one of a non-rotating component of a polish rod connection assembly or a rotating component of the polish rod connection assembly; and
a target configured to couple to the other of the non-rotating component of the polish rod connection assembly or the rotating component of the polish rod connection assembly, wherein a property of the target varies substantially continuously along a circumferential extent of the target, and the sensor is configured to output a sensor signal indicative of the property of the target.

2. The rotation monitoring assembly of claim 1, wherein the non-rotating component comprises a housing of a rod rotator assembly, the sensor is configured to couple to the housing of the rod rotator assembly, the rotating component comprises a rotating portion of the rod rotator assembly, and the target is configured to couple to the rotating portion of the rod rotator assembly.

3. The rotation monitoring assembly of claim 1, wherein the sensor comprises a contact element, the target comprises a contact surface configured to engage the contact element of the sensor, and the property of the target comprises a longitudinal extent of the contact surface.

4. The rotation monitoring assembly of claim 2, wherein the sensor comprises a linear variable differential transformer (LVDT).

5. The rotation monitoring assembly of claim 2, wherein the contact surface of the target forms a wave pattern.

6. The rotation monitoring assembly of claim 1, wherein the sensor is configured to output the sensor signal via a wired connection.

7. A rotation monitoring assembly for an artificial lift system, comprising:
a sensor comprising a contact element and a body, wherein the body is configured to couple to one of a housing of a rod rotator assembly or a rotating portion of the rod rotator assembly, and the sensor is configured to output a sensor signal indicative of a position of the contact element relative to the body; and
a target configured to couple to the other of the housing of the rod rotator assembly or the rotating portion of the rod rotator assembly, wherein the target comprises a contact surface configured to engage the contact element of the sensor, and a longitudinal extent of the contact surface varies along a circumferential extent of the target.

8. The rotation monitoring assembly of claim 7, wherein the sensor comprises a linear variable differential transformer (LVDT).

9. The rotation monitoring assembly of claim 7, comprising a clamp configured to couple the target to the rotating portion of the rod rotator assembly, wherein the body of the sensor is configured to couple to the housing of the rod rotator assembly.

10. The rotation monitoring assembly of claim 7, wherein the contact surface of the target forms a wave pattern.

11. The rotation monitoring assembly of claim 7, wherein the target extends about a portion of a circumferential extent of the rod rotator assembly.

12. The rotation monitoring assembly of claim 7, comprising a strap configured to couple the body of the sensor to the housing of the rod rotator assembly, wherein the target is configured to couple to the rotating portion of the rod rotator assembly.

13. The rotation monitoring assembly of claim 7, wherein the sensor is configured to output the sensor signal via a wired connection.

14. A rotation monitoring assembly for an artificial lift system, comprising:
a sensor comprising a contact element and a body, wherein the sensor is configured to output a sensor signal indicative of a position of the contact element relative to the body;
a mount configured to couple the body to a housing of a rod rotator assembly; and
a target configured to couple to a top cap of the rod rotator assembly, wherein the target comprises a contact surface configured to engage the contact element of the sensor, and a longitudinal extent of the contact surface varies along a circumferential extent of the target.

15. The rotation monitoring assembly of claim 14, wherein the mount comprises an arcuate support configured to extend about a portion of a periphery of the housing of the rod rotator assembly and to couple to the housing of the rod rotator assembly.

16. The rotation monitoring assembly of claim 15, wherein the mount comprises a bracket coupled to the arcuate support and to the body of the sensor.

17. The rotation monitoring assembly of claim 14, wherein the target is annular and extends about an entire periphery of the top cap of the rod rotator assembly.

18. The rotation monitoring assembly of claim 14, wherein the sensor comprises a linear variable differential transformer (LVDT).

19. The rotation monitoring assembly of claim 14, wherein the contact surface of the target forms a wave pattern.

20. The rotation monitoring assembly of claim 14, wherein the sensor is configured to output the sensor signal via a wired connection.
